(19) United States
(12) Patent Application Publication
(10) Pub. No.: US 2026/0189513 A1
(43) Pub. Date: Jul. 2, 2026

(54) CONFIGURATION OF MAXIMUM TRANSMISSION UNIT (MTU) IN A NETWORK INTERFACE DEVICE

(71) Applicant: Intel Corporation, Santa Clara, CA (US)

(72) Inventors: Andrey CHILIKIN, Limerick (IE); Andrew CUNNINGHAM, Ennis (IE); Brian P. JOHNSON, Forest Grove, OR (US); Patrick G. KUTCH, Tigard, OR (US)

(21) Appl. No.: 19/548,476

(22) Filed: Feb. 24, 2026

(51) Int. Cl. H04L 47/36; H04L 47/43

(52) U.S. Cl. CPC H04L 47/36; H04L 47/43

(57) ABSTRACT

Examples described herein relate to a network interface device. The network interface device includes a host interface; a network interface; a direct memory access (DMA) circuitry; and a circuitry. In some examples, the circuitry is to determine a change in Maximum Transmission Unit (MTU) size of received packets associated with a first Internet Protocol (IP) flow and modify an MTU size of transmitted packets associated with the first IP flow based on the determined changed MTU size.

### BACKGROUND

A host computer utilizes a network interface device to share data with another host computer. When a size of a packet exceeds a network link's Maximum Transmission Unit (MTU), application of Internet Protocol (IP) fragmentation breaks down IP packets into smaller fragments. These fragments are transmitted independently and reassembled at the destination using identification, flags, and offset fields.

### BRIEF DESCRIPTION OF THE DRAWINGS

FIG. 1 depicts an example system.

FIG. 2 depicts a system.

FIG. 3 shows an example operation of a system.

FIGS. 4A and 4B depict example network interface devices.

FIG. 5 depicts an example network interface device.

FIG. 6 depicts an example process.

FIG. 7 depicts an example system.

### DETAILED DESCRIPTION

Various examples include a network interface device determining an MTU of an Internet Protocol (IP) flow based on the network interface device performing offloaded reassembly of packet fragments into a packet and, based on a change in the MTU of the flow, adjusting an MTU of packets of the IP flow, that utilized by a packet fragmentation operation offloaded to the network interface device. In some examples, the network interface device can report the changed MTU of the flow to a host system executed operating system (OS), driver, or other software and the OS, driver, or other software can adjust the MTU of packet fragments of the flow that are to be transmitted.

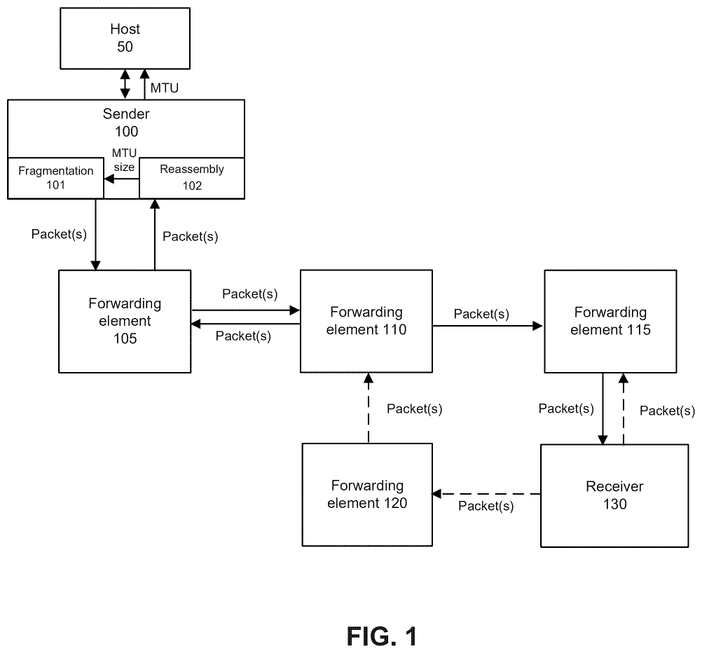

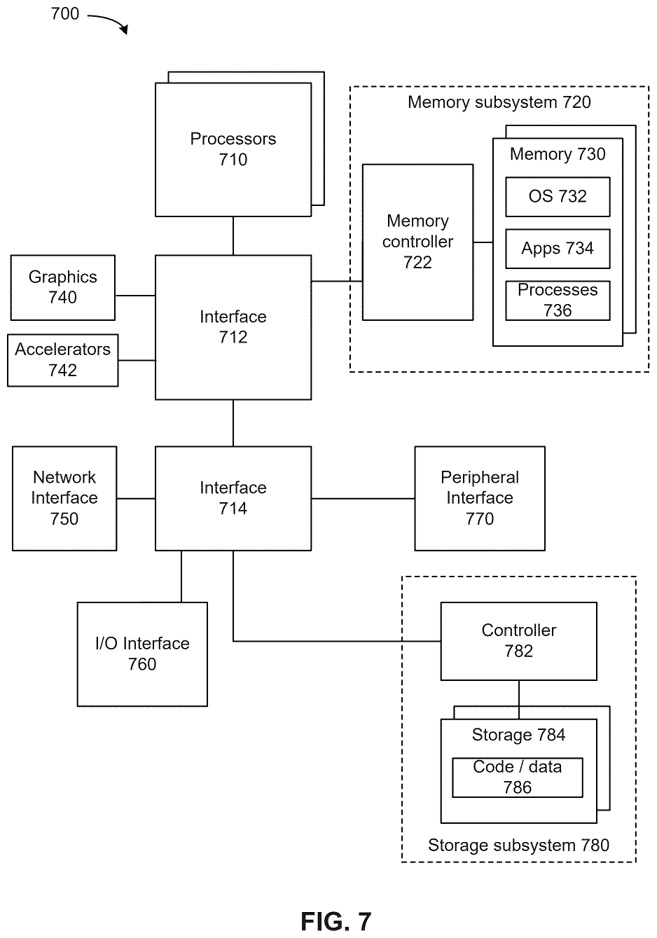

FIG. 1 depicts an example system. Sender network device 100 can include a network interface device that, at a request of host system 50, sends one or more packets to receiver 130, via one or more switches, such as forwarding elements 105, 110, and 115. Packets of a flow or tunnel can traverse one or more routes or paths from sender 100, through forwarding elements, to receiver 130. An example of host system 50 is described at least with respect to FIG. 7. A network device can include a forwarding element, network interface device, or other devices. In some examples, a network interface device can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance. Forwarding elements 105, 110, and/or 115 can be implemented as one or more of: network interface controller (NIC), SmartNIC, router, top of rack (ToR) switch, switch, infrastructure processing unit (IPU), or data processing unit (DPU).

As described herein, during packet reassembly by reassembly circuitry 102, sender 100 can discover changes in MTU size for packets and/or packet flow or a route for packets from endpoint receiver 130 to sender 100 and reassembly circuitry 102 can adjust an MTU that fragmentation circuitry 101 is to apply for transmitted fragmented or non-fragmented packets. For example, to adjust an MTU of fragmentation circuitry 101, reassembly circuitry 102 can be configured as a trusted source of changing MTU of fragmentation circuitry 101.

In some examples, instead of reassembly circuitry 102 adjusting an MTU applied by fragmentation circuitry 101, reassembly circuitry 102 can communicate a change in MTU to host system 50. Host system 50 can execute software (e.g., driver for sender 100 or operating system (OS)) to control a size of fragments generated by fragmentation circuitry 101 for a particular route or flow on transmit based on an MTU reported to host system 50 by reassembly circuitry 102.

Configuration of sender network device 100 can be consistent with versions of Network Driver Interface Specification (NDIS), Network Adapter Class Extension (NetAdapterCx), or others. For example, network device 100 can advertise capabilities for reassembly circuitry 102 to detect and adjust an MTU size configuration of fragmentation circuitry 101. Operating system (OS) or driver 200 can enable or disable the capabilities by calling an API.

A packet may be used herein to refer to various formatted collections of bits that may be sent across a network, such as Ethernet frames, Internet Protocol (IP) packets (e.g., IPv4 or IPv6), Transmission Control Protocol (TCP) segments, User Datagram Protocol (UDP) datagrams, etc. A flow can be a sequence of packets being transferred between two endpoints, generally representing a single session using a protocol. Accordingly, a flow can be identified by a set of defined tuples and, for routing purpose, a flow is identified by the two tuples that identify the endpoints, e.g., the source and destination addresses. For content-based services (e.g., load balancer, firewall, Intrusion detection system etc.), flows can be identified at a finer granularity by using N-tuples (e.g., source IP address, destination IP address, IP protocol, transport layer source port, or destination port). A packet in a flow can have the same set of tuples in the packet header. A packet flow to be controlled can be identified by a combination of tuples (e.g., Ethernet type field, source IP address, destination IP address, source media access control (MAC) address, destination MAC address, source User Datagram Protocol (UDP) port, destination UDP port, source TCP port, destination TCP port, or any other header field) and a unique queue pair (QP) number or identifier.

Reference to flows can instead or in addition refer to tunnels (e.g., Multiprotocol Label Switching (MPLS) Label Distribution Protocol (LDP), Segment Routing over IPv6 data plane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

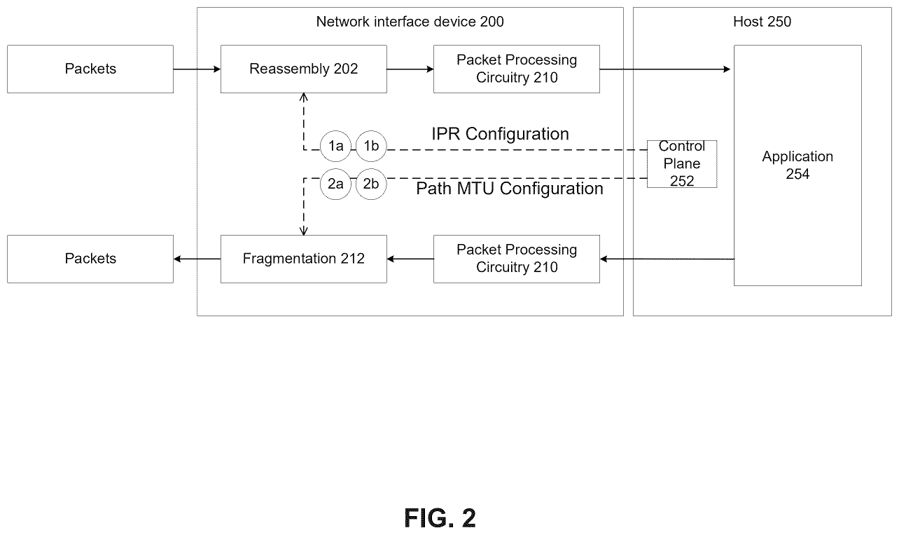

FIG. 2 depicts a system in which packet reassembly and fragmentation are offloaded to a network interface device. Various examples of host 250 are described at least with respect to FIG. 7, among other places. Control plane software 252 executing on host 250 can configure network interface device 200 at initialization time. Configuration of reassembly circuitry 202 can include 1a or 1b, 1b followed by 1a, or 1a followed by 1b. At 1a, control plane 252 can configure reassembly circuitry 202 to apply a maximum number of fragments for a packet, biggest fragment size (e.g., MTU), smallest fragment size, or others. Control plane 252 can set the configuration for no packet flow, a strict subset of packet flows, or all packet flows received by reassembly circuitry 202. When received IP packets were fragmented into packets that meet MTU size constraints, reassembly circuitry 202 can form a packet from its packet fragments. Network interface device 200 can store packet fragments in a buffer, using a key (e.g., source IP address, destination IP address, protocol, or others) to match fragments to a packet to be reconstructed.

At 1b. control plane 252 can configure reassembly circuitry 202 to perform reassembly of packets for particular flows. If a flow is not specified for reassembly in the configuration, reassembly circuitry 202 does not perform reassembly of fragments for packets of the flow. For example, reassembly circuitry 202 can apply access control list (ACL) to select packet fragments to reassemble, based on the configuration. If a received packet or fragment is under a smallest permitted fragment size, then the packet can be dropped and reassembly circuitry 202 or packet processing circuitry 210 can inform control plane 252 or application 254 that a received packet size was too small and control plane 252 or application 254 can perform a corrective action (e.g., adjust smallest fragment size, indicate a denial of service attack is potentially occurring, or others). For example, a denial of service attack could send packets having a size smaller than the valid range in an attempt to overload the receiver and disrupt operation of host 250 or network interface device 250.

When an IP packet to be transmitted exceeds the permitted size for a network segment (e.g., MTU), fragmentation circuitry 212 can split the packet into multiple smaller packets, each with its own header. Packet reassembly can be performed at the destination network interface device.

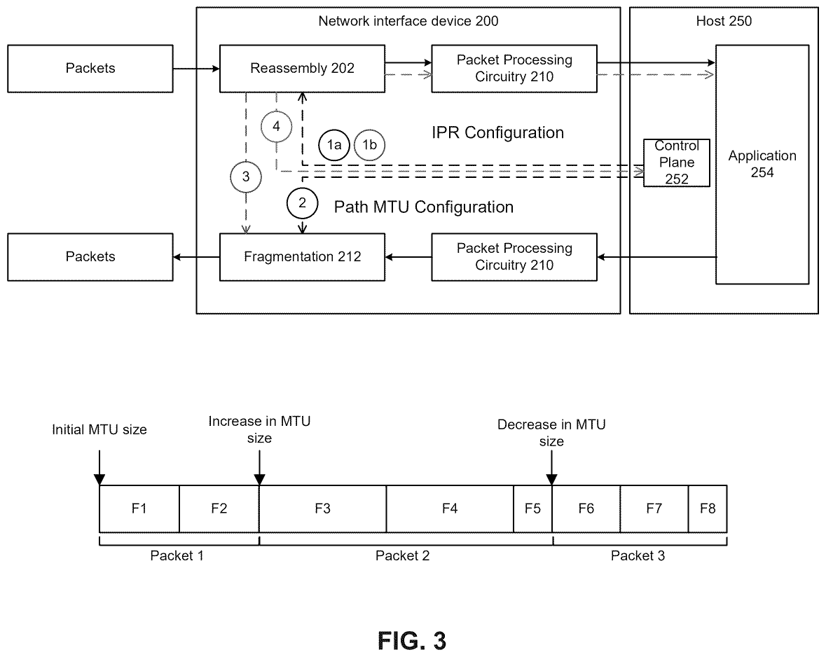

FIG. 3 shows an example operation of a system. After 1a or 1b, at 2, reassembly circuitry 202 can detect a change in MTU size from received packets and report the changed MTU size to fragmentation circuitry 212. Reassembly circuitry 202 can detect increases or decreases to sizes of received packet fragments (MTUs) for a flow (e.g., one or more of: source media access control (MAC) address, destination MAC address, source IP address, and/or destination IP address) utilizing technologies described herein. Reassembly circuitry 202 can detect fragment sizes from reassembling packet fragments into a packet. For example, reassembly circuitry 202 can reassemble packet fragments F1 and F2 into packet 1, packet fragments F3-F5 into packet 2, and packet fragments F6-F8 into packet 3. For example, reassembly circuitry 202 can detect an increase in MTU size from packet 1 to packet 2, and can detect a decrease in MTU size from packet 2 to packet 3. Reassembly circuitry 202 can determine an MTU from the largest fragment size for a packet (e.g., F3 and F4, F6 and F7). As fragments F5 and F8 are smaller than the MTU for the packets 2 and 3, the size of F5 and F8 are not considered in an MTU for packets 2 and 3.

For example, reassembly circuitry 202 can determine a change in MTU size by tracking fragment sizes received from an endpoint sender, flow, or path. When a change occurs, such as an increase or decrease in fragment size, at 3, reassembly circuitry 202 can notify fragmentation circuitry 212 of the updated MTU size for a sender, flow, or path. Based on a configuration to apply an updated MTU size from reassembly circuitry 202, fragmentation circuitry 212 can apply the updated MTU configuration from reassembly circuitry 202. Based on a configuration to not apply an updated MTU size from reassembly circuitry 202, fragmentation circuitry 212 may not apply the updated MTU configuration from reassembly circuitry 202.

At least to secure configuration of MTU size detected by reassembly circuitry 202 and to be applied by fragmentation circuitry 212 as trusted, control plane 252 can configure reassembly circuitry 202 to send a configuration of MTU size to fragmentation circuitry 212 for particular senders, flows, or routes and/or configure fragmentation circuitry 212 to accept MTU size configurations from reassembly circuitry 202 for particular senders, flows, or routes. For example, control plane 252 can issue a configuration to fragmentation circuitry 212 that specifies at least: permitted adjuster of MTU (e.g., reassembly circuitry 202, control plane 252, or application 254), flow identifier (e.g., source MAC address, destination MAC address, source IP address, destination IP address, or others), permitted MTU size, smallest permitted packet size, or others. In some examples, MTU size configuration can be enabled for flows that were successfully encrypted, decrypted, or authenticated by packet processing pipeline 210.

Various examples of discovery of MTU size for a path or flow are as follows. Path MTU Discovery (PMTUD) can be achieved based at least on Internet Engineering Task Force (IETF) Request for Comments (RFC) 8899, “Packetization Layer Path MTU Discovery for Datagram Transports” (September 2020); Network Working Group Request for Comments (RFC) 1191 (November 1990); IETF RFC 8201 (July 2017); Internet Control Message Protocol (ICMP) Discovery (e.g., Network Working Group Request for Comments (RFC) 1191 (1990)); or others.

To discover an MTU size for a path or flow, host 250 can send packets with the Don't Fragment (DF) bit set and if a router or switch cannot forward a packet because it is too large for the next link, the router or switch drops the packet and sends an Internet Control Message Protocol (ICMP) Type 3, Code 4 (IPv4) or Type 2 (IPv6) message back to the sender and the sender can lower the MTU based on the value suggested in that ICMP message. In some examples, when a router or switch receives an IPv6 packet larger than the MTU of the next link, the router or switch drops the packet and sends an ICMPv6 Packet Too Big (PTB) message to the sender.

At 4, alternatively, or in addition to sending a notification indicating a change in MTU size to fragmentation circuitry 212, reassembly circuitry 202 can report the detected MTU size to control plane 252 or application 254 by providing the changed MTU size in a packet receive descriptor. Application 254 can use this MTU data information to send packets that meet the MTU and avoid fragmentation or cause transmission of packets having a size up to the MTU by indication of MTU size in a packet transmit descriptor. Control plane 252 may aggregate changes in MTU size detected by reassembly circuitry 202 to adjust network settings in case of misconfiguration or to detect potential distributed denial-of-service (DDoS) attacks.

Until proper MTU values are applied to hardware configurations, devices may continue to use incorrect MTU settings for fragmentation, which can cause packets to be dropped due to oversized fragments or lead to network underutilization if fragments are too small. However, communication of a change in MTU by reassembly circuitry 202 to fragmentation circuitry 212, at 3, can reduce a time that incorrect MTU settings are utilized, thereby potentially increasing utilization and reducing downtime. Reducing the need for an operating system stack to adjust IP fragmentation parameters can reduce packet loss, increase network utilization, and enhance system performance and reliability.

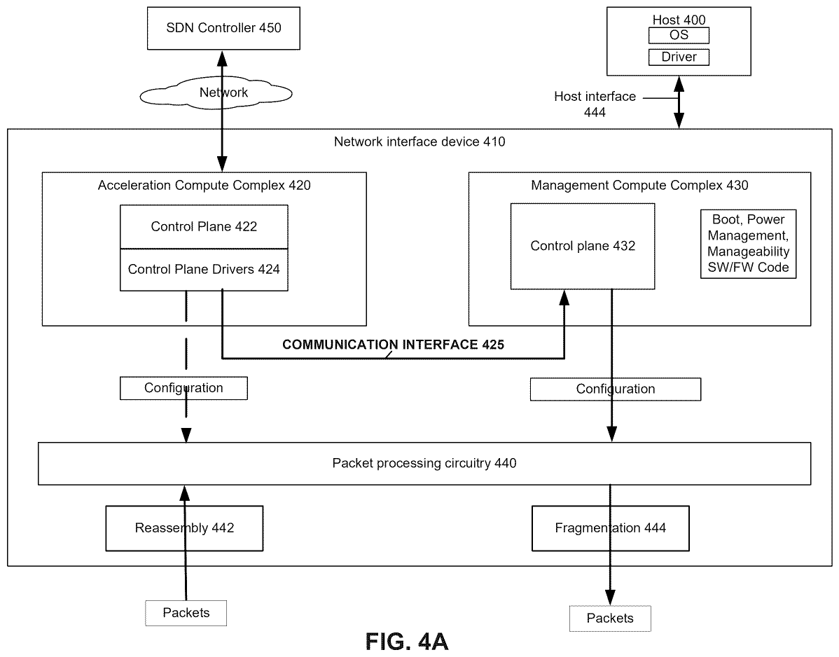

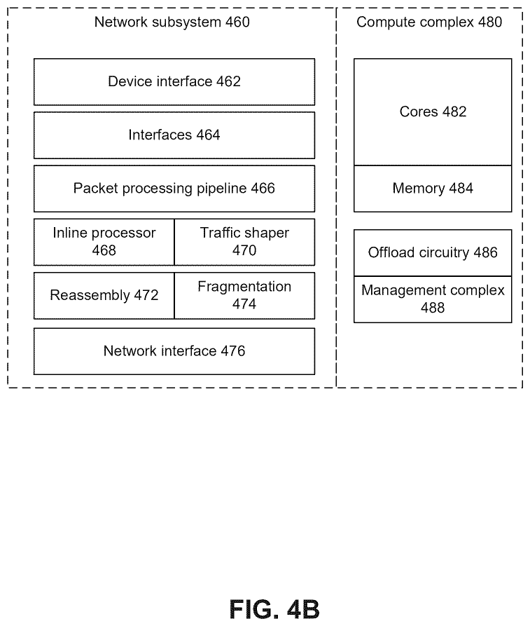

FIG. 4A depicts an example system. Host 400 can include processors, memory devices, device interfaces, as well as other circuitry described herein. Processors of host 400 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 410 to utilize one or more control planes to communicate with software defined networking (SDN) controller 450 via a network to configure operation of the one or more control planes. Host 400 can be coupled to network interface device 410 via a host or device interface 444.

As described herein, reassembly circuitry 442 can be configured to detect a change in MTU size (e.g., increase or decrease in MTU size) for a flow or path and configure fragmentation circuitry 444 with the changed MTU size so that fragmentation circuitry 444 can apply the MTU for packets egressing for the flow or path.

Network interface device 410 can include multiple compute complexes, such as an Acceleration Compute Complex (ACC) 420 and Management Compute Complex (MCC) 430, as well as packet processing circuitry 440 and network interface technologies for communication with other devices via a network. ACC 420 can be implemented as one or more of: a microprocessor, processor, accelerator, field programmable gate array (FPGA), application specific integrated circuit (ASIC) or circuitry described herein. Similarly, MCC 430 can be implemented as one or more of: a microprocessor, processor, accelerator, field programmable gate array (FPGA), application specific integrated circuit (ASIC) or circuitry described herein. In some examples, ACC 420 and MCC 430 can be implemented as separate cores in a CPU, different cores in different CPUs, different processors in a same integrated circuit, different processors in different integrated circuit. In some examples, ACC 420 may not be used and host 400 can execute control plane 422 and control plane drivers 424.

Network interface device 410 can be implemented as one or more of: a microprocessor, processor, accelerator, field programmable gate array (FPGA), application specific integrated circuit (ASIC) or circuitry described herein. Packet processing pipeline circuitry 440 can process packets as directed or configured by one or more control planes executed by multiple compute complexes. In some examples, ACC 420 and MCC 430 can execute respective control planes 422 and 432.

SDN controller 450 can upgrade or reconfigure software executing on ACC 420 (e.g., control plane 422 and/or control plane 432) through contents of packets received through packet processing device 410. In some examples, ACC 420 can execute control plane operating system (OS) (e.g., Linux) and/or a control plane application 422 (e.g., user space or kernel modules) used by SDN controller 450 to configure operation of packet processing pipeline 440. Control plane application 422 can incude Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 450 can communicate with ACC 420 using a remote procedure call (RPC) such as Google remote procedure call (gRPC) or other service and ACC 420 can convert the request to target specific protocol buffer (protobuf) request to MCC 430. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 450 can provide packet processing rules for performance by ACC 420. For example, ACC 420 can program table rules (e.g., header field match and corresponding action) applied by packet processing pipeline circuitry 440 based on change in policy and changes in VMs, containers, microservices, applications, or other processes. ACC 420 can be configured to provide network policy as flow cache rules into a table to configure operation of packet processing pipeline 440. For example, the ACC-executed control plane application 422 can configure rule tables applied by packet processing pipeline circuitry 440 with rules to define a traffic destination based on packet type and content. ACC 420 can program table rules (e.g., match-action) into memory accessible to packet processing pipeline circuitry 440 based on change in policy and changes in VMs.

For example, ACC 420 can execute a virtual switch such as vSwitch or Open vSwitch (OVS), Stratum, or Vector Packet Processing (VPP) that provides communications between virtual machines executed by host 400 or with other devices connected to a network. For example, ACC 420 can configure packet processing pipeline circuitry 440 as to which VM is to receive traffic and what kind of traffic a VM can transmit. For example, packet processing pipeline circuitry 440 can execute a virtual switch such as vSwitch or Open vSwitch that provides communications between virtual machines executed by host 400 and packet processing device 410.

MCC 430 can execute a host management control plane, global resource manager, and perform hardware registers configuration. Control plane 432 executed by MCC 430 can perform provisioning and configuration of packet processing circuitry 440. For example, a VM executing on host 400 can utilize packet processing device 410 to receive or transmit packet traffic. MCC 430 can execute boot, power, management, and manageability software (SW) or firmware (FW) code to boot and initialize the packet processing device 410, manage the device power consumption, provide connectivity to a management controller (e.g., Baseboard Management Controller (BMC)), and other operations.

One or both control planes of ACC 420 and MCC 430 can define traffic routing table content and network topology applied by packet processing circuitry 440 to select a path of a packet in a network to a next hop or to a destination network-connected device. For example, a VM executing on host 400 can utilize packet processing device 410 to receive or transmit packet traffic.

ACC 420 can execute control plane drivers to communicate with MCC 430. At least to provide a configuration and provisioning interface between control planes 422 and 432, communication interface 425 can provide control-plane-to-control plane communications. Control plane 432 can perform a gatekeeper operation for configuration of shared resources. For example, via communication interface 425, ACC control plane 422 can communicate with control plane 432 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 425 can be utilized by a negotiation protocol and configuration protocol running between ACC control plane 422 and MCC control plane 432. Communication interface 425 can include a general purpose mailbox for different operations performed by packet processing circuitry 440. Examples of operations of packet processing circuitry 440 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 425 can include one or more mailboxes accessible as registers or memory addresses. For communications from control plane 422 to control plane 432, communications can be written to the one or more mailboxes by control plane drivers 424. For communications from control plane 432 to control plane 422, communications can be written to the one or more mailboxes. Communications written to mailboxes can include descriptors which include message opcode, message error, message parameters, and other information. Communications written to mailboxes can include defined format messages that convey data.

Communication interface 425 can provide communications based on writes or reads to particular memory addresses (e.g., dynamic random access memory (DRAM)), registers, other mailbox that is written-to and read-from to pass commands and data. To provide for secure communications between control planes 422 and 432, registers and memory addresses (and memory address translations) for communications can be available only to be written to or read from by control planes 422 and 432 or cloud service provider (CSP) software executing on ACC 420 and device vendor software, embedded software, or firmware executing on MCC 430. Communication interface 425 can support communications between multiple different compute complexes such as from host 400 to MCC 430, host 400 to ACC 420, MCC 430 to ACC 420, management controller to MCC 430, management controller to ACC 420, or management controller to host 400.

Packet processing circuitry 440 can be implemented using one or more of: application specific integrated circuit (ASIC), field programmable gate array (FPGA), processors executing software, or other circuitry. Control plane 422 and/or 432 can configure packet processing pipeline circuitry 440 or other processors to perform operations related to one or more of: storage access (e.g., NVMe or NVMe-oF reads or writes), lookaside crypto Engine (LCE), Address Translation Engine (ATE), local area network (LAN), remote direct memory access (RDMA), compression/decompression, encryption/decryption, or other accelerated operations.

Various message formats can be used to configure ACC 420 or MCC 430. In some examples, a P4 program can be compiled and provided to MCC 430 to configure packet processing circuitry 440. The following is a JSON configuration file that can be transmitted from ACC 420 to MCC 430 to get capabilities of packet processing circuitry 440 and/or other circuitry in packet processing device 410. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 4B depicts an example network interface device system. Various examples of packet processing device or network interface device 410 (FIG. 4A) can utilize examples of circuitry and software described herein. In some examples, packet processing device or network interface device can include one or more of: a network interface controller (NIC), a remote direct memory access (RDMA)-enabled NIC, SmartNIC, router, switch, forwarding element, infrastructure processing unit (IPU), or data processing unit (DPU). Network subsystem 460 can be communicatively coupled to compute complex 480. Device interface 462 can provide an interface to communicate with a host. Various examples of device interface 462 can utilize protocols based on Peripheral Component Interconnect Express (PCIe), Compute Express Link (CXL), or others as well as virtual device interface such as virtual device interfaces.

Peripheral Component Interconnect express (PCIe) is described at least in Peripheral Component Interconnect (PCI) Express Base Specification 1.0 (2002), as well as earlier versions, later versions, and variations thereof. Compute Express Link (CXL) is described at least in Compute Express Link Specification version 1.0 (2019), as well as earlier versions, later versions, and variations thereof.

Interfaces 464 can initiate and terminate at least offloaded remote direct memory access (RDMA) operations, Non-volatile memory express (NVMe) reads or writes operations, and LAN operations. Packet processing pipeline 466 can perform packet processing (e.g., packet header and/or packet payload) based on a configuration and support quality of service (QoS) and telemetry reporting. Inline processor 468 can perform offloaded encryption or decryption of packet communications (e.g., Internet Protocol Security (IPSec) or others). Traffic shaper 470 can schedule transmission of communications by network subsystem 460. As described herein, fragmentation circuitry 474 can be configured by reassembly circuitry 472 or cores 482 to adjust an MTU of transmitted packets. Network interface 476 can provide an interface at least to an Ethernet network by media access control (MAC) and serializer/de-serializer (Serdes) operations.

Cores 482 can be configured to perform infrastructure operations such as storage initiator, Transport Layer Security (TLS) proxy, virtual switch (e.g., vSwitch), or other operations. Memory 484 can store applications and data to be performed or processed. Offload circuitry 486 can perform at least cryptographic and compression operations for host or use by compute complex 480. Offload circuitry 486 can include one or more graphics processing units (GPUs) that can access memory 484. Management complex 488 can perform secure boot, life cycle management and management of network subsystem 460 and/or compute complex 480.

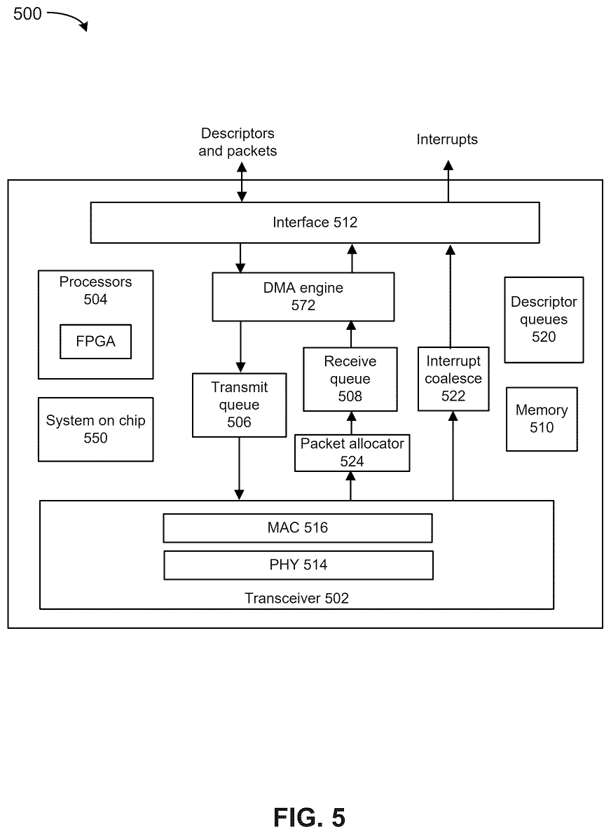

FIG. 5 depicts an example network interface device or packet processing device. Examples described herein can utilize circuitry of the network interface device or packet processing device. In some examples, packet processing device 500 can be implemented as a network interface controller, network interface card, a host fabric interface (HFI), or host bus adapter (HBA), and such examples can be interchangeable. Packet processing device 500 can be coupled to one or more servers using a bus, PCIe, CXL, or Double Data Rate (DDR). Packet processing device 500 may be embodied as part of a system-on-a-chip (SoC) that includes one or more processors, or included on a multichip package that also contains one or more processors.

Some examples of packet processing device 500 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and host interface 512, and DMA engine 552. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to assemble data to be transmitted into packets, that include destination and source addresses along with network control information and error detection hash values.

System on chip (SoC) 550 and processors 504 can include any a combination of:
processor, core, graphics processing unit (GPU), field programmable gate array (FPGA), application specific integrated circuit (ASIC), or other programmable hardware device that allow programming of network interface 500. For example, a “smart network interface” can provide packet processing capabilities in the network interface using processors 504.

Processors 504 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 504, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 524 can provide distribution of received packets for processing by multiple CPUs or cores using timeslot allocation or receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Host interface 512 can provide an interface with host device (not depicted). For example, host interface 512 can be compatible with PCI, PCI Express, PCI-x, Serial ATA, and/or USB compatible interface (although other interconnection standards may be used).

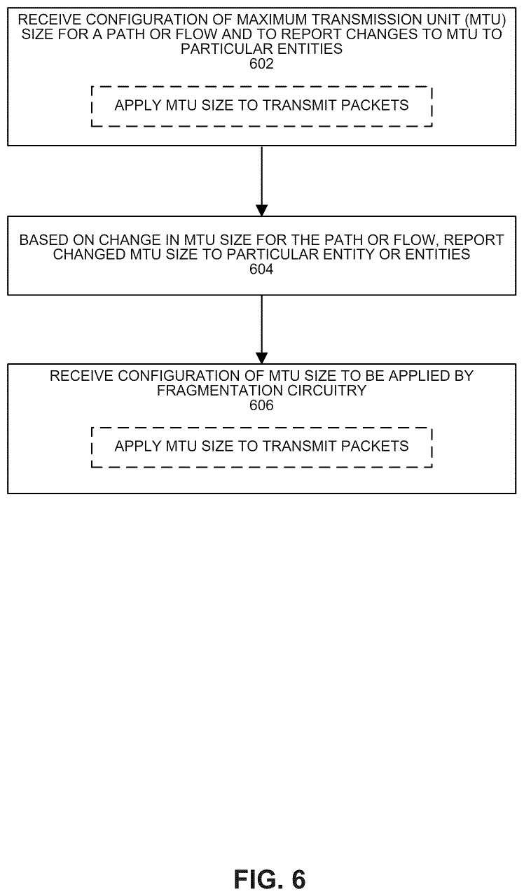

FIG. 6 depicts an example process. The process can be performed by a network interface device or packet processing device, in some examples. At 602, a configuration of an MTU size can be applied to a reassembly circuitry of the network interface device. The configuration, or another configuration, can configure reassembly circuitry to detect an MTU for a path to an endpoint receiver or flow and indicate, to a fragmentation circuitry of the network interface device, an MTU for packets to be transmitted for the path to an endpoint receiver or flow. The configuration can allow the MTU of the fragmentation circuitry, for particular flows or paths, to be configured by the reassembly circuitry. The fragmentation circuitry can apply the MTU for packets to be transmitted by a particular path to an endpoint receiver or for a particular flow so that transmitted packets or packet fragments do not exceed the MTU. At 604, based on a change in detected MTU for the path or flow, the reassembly circuitry can report the changed MTU size. The reassembly circuitry can report the changed MTU size to the fragmentation circuitry, control plane software, orchestrator, and/or operating system. An MTU can be discovered using technologies described herein.

At 606, the fragmentation circuitry can be configured to apply the MTU for a path to an endpoint receiver or flow. In some examples, the reassembly circuitry can be identified as a trusted source to change an MTU applied by fragmentation circuitry and the reassembly circuitry can change an MTU of fragmentation circuitry. In some examples, a host system executed operating system can receive an indication of change in MTU size and configure fragmentation circuitry with an MTU for a path or flow. The fragmentation circuitry can apply the configured MTU so that transmitted packets or packet fragments do not exceed the MTU.

FIG. 7 depicts a system. In some examples, fragmentation of transmitted packets performed by network interface device 750 can comply with an MTU for a path to an endpoint receiver or a flow from a packet fragment reassembly circuitry, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 710 can include multiple processors and multiple processors can be embodied as processor sockets.

In one example, system 700 includes interface 712 coupled to processor 710, which can represent a higher speed interface or a high throughput interface for system components, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the artificial intelligence (AI) model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container (e.g., Docker container), microservice, processor, or other software. Various examples can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

OS 732 can advertise capability of network interface 750 to detect and adjust an MTU size configuration of fragmentation circuitry 101. Operating system (OS) or driver 732 can enable or disable the capabilities by calling an API, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers, workstations, or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 700 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more later examples and includes an apparatus that includes: a network interface device comprising: a network interface; a host interface; a direct memory access (DMA) circuitry; and circuitry to: determine a change in Maximum Transmission Unit (MTU) size of received packets associated with a first Internet Protocol (IP) flow and modify an MTU size of transmitted packets associated with the first IP flow based on the determined changed MTU size.

Example 2 includes one or more later or earlier examples, wherein the circuitry is to perform reassembly of packet fragments into a received packet and determine the MTU size based on the packet reassembly.

Example 3 includes one or more later or earlier examples, wherein the circuitry is to modify the MTU size of transmitted packets based on permission in a security configuration for the circuitry to modify the MTU size of transmitted packets.

Example 4 includes one or more later or earlier examples, wherein the circuitry is to notify an operating system (OS) of the changed MTU size.

Example 5 includes one or more later or earlier examples, wherein the OS to specify the changed MTU size for packets to be transmitted.

Example 6 includes one or more later or earlier examples, wherein the circuitry is configured to retain MTU size of a packets associated with a second flow despite a change in MTU size of the first flow.

Example 7 includes one or more later or earlier examples, and includes a method comprising: a network interface device performing: determining a change in Maximum Transmission Unit (MTU) size of received packets associated with a first Internet Protocol (IP) flow and modifying an MTU size of transmitted packets associated with the first IP flow based on the determined changed MTU size, wherein the network interface device comprises a network interface, a host interface, and a direct memory access (DMA) circuitry.

Example 8 includes one or more later or earlier examples, and includes performing reassembly of packet fragments into a received packet and determining the MTU size based on the reassembly of packet fragments.

Example 9 includes one or more later or earlier examples, and includes modifying the MTU size of transmitted packets based on permission in a security configuration to permit modification of the MTU size determined during packet reassembly.

Example 10 includes one or more later or earlier examples, and includes notifying an operating system (OS) of a changed MTU size and the OS specifying the changed MTU size for packets to be transmitted.

Example 11 includes one or more later or earlier examples, and includes retaining an MTU size of a packets associated with a second flow despite a change in MTU size of the first flow.

Example 12 includes one or more later or earlier examples, and includes at least one non-transitory computer-readable medium comprising instructions stored thereon, that if executed by one or more processors, cause the one or more processors to: configure a network interface device to: indicate a capability to determine a change in Maximum Transmission Unit (MTU) size of received packets associated with a first Internet Protocol (IP) flow and modify an MTU size of transmitted packets associated with the first IP flow based on the determined changed MTU size, wherein the network interface device comprises a network interface, a host interface, and a direct memory access (DMA) circuitry and based on a request to perform the capability, enable the capability in the network interface device.

Example 13 includes one or more later or earlier examples, and includes instructions stored thereon, that if executed by the one or more processors, cause the one or more processors to: configure the network interface device to perform reassembly of packet fragments into a received packet and determine the MTU size based on the reassembly of the packet fragments into a packet.

Example 14 includes one or more later or earlier examples, and includes instructions stored thereon, that if executed by the one or more processors, cause the one or more processors to: configure the network interface device to modify the MTU size of transmitted packets based on permission in a security configuration to modify the MTU size of transmitted packets based on packet reassembly.

Example 15 includes one or more earlier examples, and includes instructions stored thereon, that if executed by the one or more processors, cause the one or more processors to: configure the network interface device to notify an operating system (OS) of a changed MTU size, wherein the OS to specify the changed MTU size for packets to be transmitted.

1. An apparatus comprising:
a network interface device comprising:
a network interface;
a host interface;
a direct memory access (DMA) circuitry; and
circuitry to:
determine a change in Maximum Transmission Unit (MTU) size of received packets associated with a first Internet Protocol (IP) flow and
modify an MTU size of transmitted packets associated with the first IP flow based on the determined changed MTU size.

2. The apparatus of claim 1, wherein the circuitry is to perform reassembly of packet fragments into a received packet and determine the MTU size based on the packet reassembly.

3. The apparatus of claim 1, wherein the circuitry is to modify the MTU size of transmitted packets based on permission in a security configuration for the circuitry to modify the MTU size of transmitted packets.

4. The apparatus of claim 1, wherein the circuitry is to notify an operating system (OS) of the changed MTU size.

5. The apparatus of claim 4, wherein the OS to specify the changed MTU size for packets to be transmitted.

6. The apparatus of claim 1, wherein the circuitry is configured to retain MTU size of a packets associated with a second flow despite a change in MTU size of the first flow.

7. A method comprising:
a network interface device performing:
determining a change in Maximum Transmission Unit (MTU) size of received packets associated with a first Internet Protocol (IP) flow and
modifying an MTU size of transmitted packets associated with the first IP flow based on the determined changed MTU size, wherein the network interface device comprises a network interface, a host interface, and a direct memory access (DMA) circuitry.

8. The method of claim 7, comprising:
performing reassembly of packet fragments into a received packet and determining the MTU size based on the reassembly of packet fragments.

9. The method of claim 7, comprising:
modifying the MTU size of transmitted packets based on permission in a security configuration to permit modification of the MTU size determined during packet reassembly.

10. The method of claim 7, comprising:
notifying an operating system (OS) of a changed MTU size and the OS specifying the changed MTU size for packets to be transmitted.

11. The method of claim 7, comprising:
retaining an MTU size of a packets associated with a second flow despite a change in MTU size of the first flow.

12. At least one non-transitory computer-readable medium comprising instructions stored thereon, that if executed by one or more processors, cause the one or more processors to:
configure a network interface device to:
indicate a capability to determine a change in Maximum Transmission Unit (MTU) size of received packets associated with a first Internet Protocol (IP) flow and modify an MTU size of transmitted packets associated with the first IP flow based on the determined changed MTU size, wherein the network interface device comprises a network interface, a host interface, and a direct memory access (DMA) circuitry and
based on a request to perform the capability, enable the capability in the network interface device.

13. The computer-readable medium of claim 12, comprising instructions stored thereon, that if executed by the one or more processors, cause the one or more processors to:
configure the network interface device to perform reassembly of packet fragments into a received packet and determine the MTU size based on the reassembly of the packet fragments into a packet.

14. The computer-readable medium of claim 12, comprising instructions stored thereon, that if executed by the one or more processors, cause the one or more processors to:
configure the network interface device to modify the MTU size of transmitted packets based on permission in a security configuration to modify the MTU size of transmitted packets based on packet reassembly.

15. The computer-readable medium of claim 12, comprising instructions stored thereon, that if executed by the one or more processors, cause the one or more processors to:
configure the network interface device to notify an operating system (OS) of a changed MTU size, wherein the OS to specify the changed MTU size for packets to be transmitted.
